(19) United States
(12) Patent Application Publication
(10) Pub. No.: US 2026/0054655 A1
(43) Pub. Date: Feb. 26, 2026

(54) Clamping Apparatus

(71) Applicant: VDL Hapro B.V., Kapelle (NL)

(72) Inventors: Menno Mastenbroek, Kapelle (NL); Paul Van Der Leest, Kapelle (NL)

(21) Appl. No.: 19/105,419

(22) PCT Filed: Aug. 22, 2023
(86) PCT No.: PCT/NL2023/050430

§ 371 Date: Feb. 21, 2025

(30) Foreign Application Priority Data
Aug. 24, 2022 (NL) 2032840

(51) Int. Cl. B60R 9/045; B60R 9/058; E04H 15/06

(52) U.S. Cl. CPC B60R 9/045; B60R 9/058; E04H 15/06

(57) ABSTRACT

There is disclosed a clamping apparatus a clamping apparatus for a roof rack profile (10), comprising:-a roof tent profile (20) comprising at least one groove (21),-a first clamping part (30) comprising a first connecting portion (31),-a second clamping part (40) comprising a second connection portion (41), wherein the second clamping part (40) is connected or connectable to the groove (21), wherein the first clamping part (30) is configured to rotate between a first rotational position for insertion into or removal from the groove (21) and a second rotational position for connecting the first clamping part in the groove and vice versa, wherein in the second rotational position of the first clamping part (30) the first clamping part and the second clamping part (40) are configured to be movable with respect to each other along the groove (21) for connecting the first connecting portion (31) and the second connecting portion (41) to each other to clamp the clamping apparatus to the roof rack profile (10).

### TECHNICAL FIELD

The present disclosure relates to a clamping apparatus and a method for clamping the clamping apparatus to a roof rack profile of a vehicle such as a car.

### BACKGROUND

A roof tent to be used on top of the roof of a car is known. For use of a roof tent, the roof tent needs to be attached to the car roof. It is important that such attachment can be performed in a user-friendly manner and/or relatively fast manner. It is an object of the present invention to provide a clamping apparatus which allows attachment of the roof tent to the car roof in a user-friendly and/or relatively fast manner.

### SUMMARY

Accordingly, the present invention provides a clamping apparatus according to claim 1.

In a further aspect, the present invention provides a method for clamping the clamping apparatus of this disclosure to a roof rack profile. The set of claims is incorporated in the description by reference for the sake of brevity.

The clamping apparatus of the invention achieves such clamping in a user-friendly manner and/or relatively fast manner. The clamping apparatus of the invention allows an easy clamping which facilitates to reduce the risk of damaging the roof rack profile and/or the roof of the car during the clamping.

The clamping apparatus according to the invention is used for clamping a roof tent to a roof rack profile provided on the roof of a vehicle such as a car. The roof tent profile of the clamping apparatus according to the invention may be fixed to the bottom of the roof tent. Alternatively, the roof tent profile of the clamping apparatus according to the invention can be attached to and detached from the bottom of the roof tent.

The first clamping part of the clamping apparatus is to be mounted to the roof tent profile of the clamping apparatus after the roof tent profile of the clamping apparatus has been positioned on the roof rack profile. The first clamping part provides user-freedom for installation as the roof tent profile can be positioned by a user on the desired position on the roof rack profile. For attachment to the groove of the roof tent profile, the groove is configured to receive the first clamping part in a first rotational position. Any position seen in the longitudinal direction of the groove can be chosen by the user for introducing the first clamping part into the groove of the roof tent profile. The first clamping part is configured to rotate between the first rotational position for insertion into the groove and a second rotational position for connecting the first clamping part in the groove. If the first clamping part should be removed from groove of the roof tent profile, the first clamping part is configured to rotate between the second rotational position into the groove and the first rotational position. Hence, the first clamping part and the groove make it possible to connect or remove the first clamping part in a relatively fast manner and/or user-friendly manner to or from any desired position seen in the longitudinal direction of the groove. The angle of rotation about the rotation axis of the first clamping part between the first and second rotational position, and vice versa, is for example 45-90 degrees. A second clamping part of the clamping apparatus comprises a second connection portion, wherein the second clamping part is connected or connectable to the groove. In the second rotational position of the first clamping part, the first clamping part and the second clamping part are configured to be movable with respect to each other along the groove for connecting the first connecting portion and the second connecting portion to each other to clamp the clamping apparatus to the roof rack profile. In this manner, an universal clamping apparatus is provided for easy attachment and/or detachment to a roof rack profile, independent of the type of the roof rack profile.

In the first rotational position, the longitudinal axis of the first connection portion may cross the groove of the roof tent profile. The first rotational position is for example a position at which the longitudinal axis of the first connection portion is perpendicular to the groove of the roof tent profile. The first clamping part can be subsequently rotated with respect to the groove from the first rotational position to the second rotational position. In the second rotational position, the longitudinal axis of the first connection portion may extend parallel to the groove of the roof tent profile.

In the second rotational position the first clamping part may be moveably connected in the groove, such that the first clamping part can be moved along the groove. For example, the first clamping part can be displaced in the groove towards the second clamping part such that the first connecting portion can establish a connection with the second connecting portion of the second clamping part.

In some embodiments, the second clamping part is insertable into the groove and rotatable with respect to the groove in a similar manner as the first clamping part. In these embodiments, the second clamping part can be configured to assume a first rotational position for insertion into or removal from the groove. In the first rotational position of the second clamping part the longitudinal axis of the second connection portion may cross the groove of the roof tent profile, and the second clamping part may also be rotatable with respect to the groove from the first rotational position to a second connecting rotational position at which the longitudinal axis of the second connecting portion extends parallel to the groove of the roof tent profile in corresponding manner as described in this disclosure for the first clamping part. In the second rotational position of the second clamping part, the second clamping part may also be moveably connected in the groove for allowing movement of the second clamping part along the groove, for example for connecting the first connecting portion with the second connecting portion. Such a clamping apparatus can be easily installed by an user by selecting at least one of the two clamping parts on the roof rack profile for movement along the groove for connecting the first connecting portion with the second connecting portion.

In some embodiments, the second clamping part can be configured such that the second connection portion is non-rotatably connected in the groove.

In some embodiments, the second clamping part can be non-moveably connected at a predetermined position along the groove.

When the first connecting portion and the second connecting portion are connected, the roof rack profile is positioned between the roof tent profile on one hand and the first clamping part and/or the second clamping part on the other hand. The roof tent profile is thus clamped to the roof rack profile.

The first connection portion can be an elongate male connector portion, such as a screw and the second connection portion can be an elongate female connection portion, such as a screw thread. Alternatively, the first connection portion can be an elongate female connection portion, such as a screw thread and the second connection portion can be an elongate male connector portion, such as a screw.

The first clamping part and/or the second clamping part are configured for receiving a tool, wherein the tool is releasably connectable with the first clamping part and/or the second clamping part. By rotating the tool in a first rotation direction the first connection portion may be connected with the second connection portion and/or by rotating the tool in an opposite second rotation direction the first connection portion may be disconnected with the second connection portion. The first connection portion and/or the second connection portion may comprise an anti-theft key hole pattern, preferably an unique anti-theft key hole pattern, and the tool comprises a key matching the anti-theft key hole pattern. The anti-theft key hole pattern may comprises a pattern of recesses, i.e. more than one recess, wherein the key of the tool may have protrusions in a matching pattern with the recesses.

Accordingly, the present invention further provides a kit of parts comprising the clamping apparatus according to the invention and the above disclosed tool.

The invention further provides a roof tent set comprising the clamping apparatus according to the invention and a roof tent having a bottom to which the clamping apparatus is attached or attachable.

The above and other aspects of the disclosure will be apparent from and elucidated with reference to the examples described hereinafter. The invention is not, however, limited to the exemplary embodiments described hereunder. Rather, a number of adaptations and modifications are possible, which also make use of the idea of the invention claimed in the claims and consequently fall within the scope of protection. In particular, the possibility is mentioned of combining the features/aspects that are only mentioned in the description and/or are shown in the figures, with the features of the claims in so far as compatible.

### BRIEF DESCRIPTION OF THE FIGURES

FIGS. 1-4 together illustrate an embodiment of the clamping apparatus of this disclosure.

### DETAILED DESCRIPTION

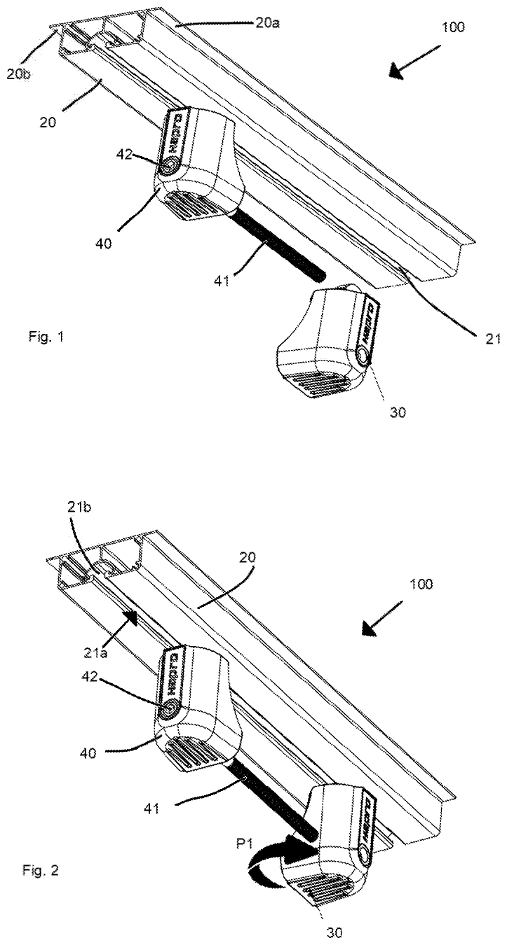

FIG. 1 further shows a clamping apparatus 100 for a roof rack profile (see FIGS. 4, 10), for example a vehicle roof rack profile.

A vehicle, like a car, normally has two parallel extending vehicle roof rack profiles for carrying for carrying a roof box or the like.

A roof tent (not shown) or rooftop tent is an accessory which also may be fitted to the roof of a motor vehicle which allows the user to sleep in relative safety and comfort above the vehicle, and leaves the internal vehicle load-space free.

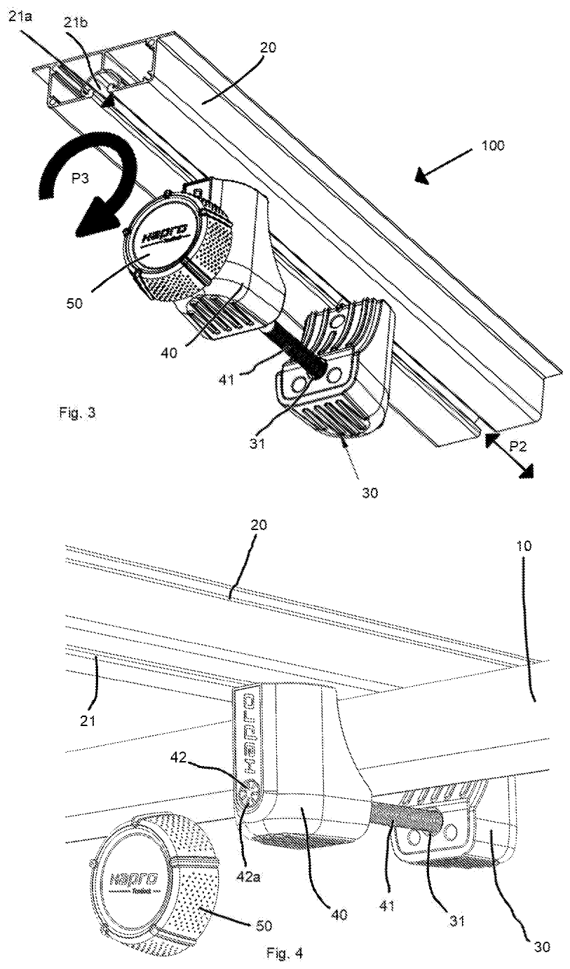

The clamping apparatus 100 comprises:
a roof tent profile 20 comprising at least one groove 21
a first clamping part 30 comprising a first connecting portion (FIG. 3 or 4, 31),
a second clamping part 40 comprising a second connection portion 41, wherein the second clamping part 40 is connected or connectable to the groove 21.

The first clamping part 30 is configured to rotate (FIG. 2, see arrow P1) between a first rotational position (FIGS. 1 and 2) for insertion into or removal from the groove 21 and a second rotational position (FIGS. 3 and 4) for connecting the first clamping part 30 in the groove 21, and vice versa. In the second rotational position of the first clamping part 30 the first clamping part and the second clamping part 40 are configured to be movable with respect to each other along the groove 21 for connecting the first connecting portion 31 and the second connecting portion 41 to each other to clamp the clamping apparatus to the roof rack profile 10. The rotational axis for rotating the first clamping part 30 for connecting or disconnecting the first clamping part 30 to the groove 21 is a vertical axis when the roof tent profile 20, in particular the groove 21, has a horizontal orientation. The angle of rotation about the rotation axis of the first clamping part 30 between the first and second rotational position for connecting (and disconnecting) the first clamping part 30 with the groove 21 is approximately 90 degrees. In the second rotational position, see FIG. 3, the first clamping part 30 is moveably connected in the groove for allowing movement of the first clamping part along the groove 21, wherein such a movement is indicated with arrow P2.

The first clamping part 30 has a hanger-like element, wherein the top section may be mushroom shaped. The groove 21 has a longitudinal opening 21a and a channel 21b. The dimensions of the top section of the hanger-like element and the channel are such that insertion into the groove 21 is only possible when the clamping part has a certain orientation with respect to the groove 21 which is the first rotational position, wherein after rotation the clamping part its top section will be supported by the channel 21b such that the clamping part will not fall out of the groove 21, i.e. is connected with the groove 21. For movement of the clamping part along the groove 21 in the direction indicated with arrow P2, the top section of the clamping part has a certain orientation with respect to the channel supporting the top section, wherein in the example shown a rotation of 90 degrees is required from the first rotational position to obtain a second rotational position allowing movement of the clamping part along the groove 21 in the direction indicated with arrow P2. Many shapes of the channel and/or the top section are possible to achieve the advantages obtained with the clamping apparatus 100 of this disclosure.

The roof tent profile 20 may be connected or connectable to the roof tent. The FIGS. 1-4 only show a portion of the roof tent profile 20. The roof tent profile 20 has for example connecting flanges 20a, 20b for connection to a base plate (not shown) or the like of the roof tent.

The elongated roof tent profile 20 has a longitudinal axis and comprising a groove 21 or groove sections (not shown) extending along the longitudinal axis of the roof tent profile 20.

The first connection portion 31 is an elongate female connector portion, and the second connection portion 41 is an elongate male connector portion, or vice versa. In the example shown, the first connection portion 31 is a screw thread and the second connection portion 41 is a screw comprising a screw head 42, wherein the screw thread matches the screw. The screw thread has a longitudinal axis, wherein in the first rotational position of the first clamping part 30 the longitudinal axis of the screw thread crosses the groove 21 of the roof tent profile 20, see FIGS. 1 and 2 wherein in the second rotational position of the first clamping part 30 the longitudinal axis of the screw thread extends parallel to the groove of the roof tent profile 20, as is shown in FIGS. 3 and 4.

The second clamping part 40 may be configured to be non-rotatably connected in the groove 21 and/or the second clamping part may be non-moveably connected at a predetermined position in the groove 21, such that only the first clamping part 30 can be moved along the groove 21 to connect the clamping parts 30, 40. In the example shown, the second clamping part 40 is insertable into the groove and rotatable with respect to the groove 21 between a first rotational position and second rotational position (and back) in a similar manner as the first clamping part described above. Hence, with reference to FIG. 4, it is now possible with the features of the clamping apparatus 100 described above to perform the method steps comprising:
i) placing the roof tent profile 20 on the roof rack profile 10 such that the groove of the roof tent profile 20 crosses the longitudinal axis of the roof rack profile 10 (see FIG. 4),
ii) inserting the first clamping part 30 into the groove 21 in the first rotational position (see FIG. 1),
iii) rotating the first clamping part 30 to the second rotational position (see FIG. 2) and
iv) moving the first clamping part 30 and the second clamping part 4 with respect to each other along the groove 21 such that the screw thread 31 and the screw 41 can be connected to each other (FIG. 3) and the roof rack profile 10 is positioned between the roof tent profile 20, the first clamping part 30 and the second clamping part 40 (FIG. 4).

With reference to FIGS. 3 and 4, the second clamping part 40 is configured for receiving a tool 50, in particular a handheld and compact tool 50 such that the tool 50 can be easily held and operated by hand, stored in a pants pocket and/or attached on a key ring. The tool 50 is adapted to be releasably connectable with the second clamping part 40 (see FIG. 4), wherein the tool is configured to rotate in a first rotation direction, see arrow P3 (FIG. 3) for connecting the screw 31 with the screw thread 41 and/or to rotate in an opposite second rotation direction, a rotation direction opposite to arrow P3, for disconnecting the screw 41 and screw thread 31 from each other. The second connection portion 41 comprises a screw head 42 having an anti-theft key hole pattern, wherein the compact tool comprises a key matching the anti-theft key hole pattern. As shown in FIG. 4, the anti-theft key hole pattern comprises more than one recess 42a, in particular multiple spaced recesses. The tool 50 has the shape of a truncated cone, wherein the distance between its top side and bottom side is 5 cm or less and its outer surface is provided with a gripping structure for facilitating rotation in and opposite the direction indicated by arrow P3 for connecting and disconnecting the screw with the screw thread.

The clamping portions are relatively compact clamping portions or at least the clamping portion that is furthest away from a user installing the clamping apparatus on a vehicle roof is a relatively compact clamping portion. A clamping portion having relatively compact dimensions has dimensions such that it is possible to move the respective clamping portion between an opening provided by a roof rack profile and a vehicle roof.

FIG. 4 shows an example of a kit of parts as claimed.

1. A clamping apparatus for a roof rack profile, the clamping apparatus comprising:
a roof tent profile comprising at least one groove;
a first clamping part comprising a first connecting portion; and
a second clamping part comprising a second connection portion wherein the second clamping part is connected or connectable to the groove and wherein:
the first clamping part is configured to rotate between a first rotational position for insertion into or removal from the groove and a second rotational position for connecting the first clamping part in the groove, and vice versa, and
in the second rotational position of the first clamping part the first clamping part and the second clamping part are configured to be movable with respect to each other along the groove for connecting the first connecting portion and the second connecting portion to each other to clamp the clamping apparatus to the roof rack profile.

2. The clamping apparatus according to claim 1, wherein the first connection portion has a longitudinal axis, wherein in the first rotational position of the first clamping part the longitudinal axis of the first connection portion crosses the groove of the roof tent profile, wherein in the second rotational position of the first clamping part the longitudinal axis of the first connection portion extends parallel to the groove of the roof tent profile

3. The clamping apparatus according to claim 2, wherein in the first rotational position of the first clamping part the longitudinal axis of the first connection portion extends perpendicular to the groove of the roof tent profile.

4. The clamping apparatus according to claim 1, wherein in the second rotational position, the first clamping part is moveably connected in the groove for allowing movement of the first clamping part along the groove.

5. The clamping apparatus according to claim 1, wherein the second connection portion of the second clamping part has a longitudinal axis, wherein the second clamping part is configured to rotate between a first rotational position for insertion into or removal from the groove and a second rotational position for connecting the second clamping part in the groove, and vice versa.

6. The clamping apparatus according to claim 5, wherein in the first rotational position of the second clamping part the longitudinal axis of the second connection portion crosses the groove of the roof tent profile wherein in the second rotational position of the second clamping part the longitudinal axis of the second connecting portion extends parallel to the groove of the roof tent profile.

7. The clamping apparatus according to claim 6, wherein in the first rotational position of the second clamping part the longitudinal axis of the second connection portion extends perpendicular to the groove of the roof tent profile.

8. The clamping apparatus according to claim 5, wherein in the second rotational position of the second clamping part, the second clamping part is moveably connected in the groove for allowing movement of the second clamping part along the groove.

9. The clamping apparatus according to claim 1, wherein the roof tent profile is an elongated roof tent profile having a longitudinal axis and the groove extends along the longitudinal axis of the roof tent profile.

10. The clamping apparatus according to claim 1, wherein the second clamping part is configured to be non-rotatably connected in the groove.

11. The clamping apparatus according to claim 1, wherein the second clamping part is non-moveably connected at a predetermined position in the groove.

12. The clamping apparatus according to claim 1, wherein the first connection portion is an elongate male connector portion, for example a screw, and the second connection portion is an elongate female connector portion, for example a screw thread, or vice versa.

13. The clamping apparatus according to claim 1, wherein at least one of the first clamping part or the second clamping part are configured for receiving a tool, wherein the tool is adapted to be releasably connectable with the at least one of the first clamping part or the second clamping part, wherein the tool is configured to rotate in at least one of a first rotation direction for connecting the first connection portion with the second connection portion or to rotate in an opposite second rotation direction for disconnecting the first connection portion and the second connection portion.

14. The clamping apparatus according to claim 13, wherein at least one of the first connection portion or the second connection portion comprises an anti-theft key hole pattern and the tool comprises a key matching the anti-theft key hole pattern, preferable the anti-theft key hole pattern comprises more than one recess.

15. A kit of parts comprising a tool and the clamping apparatus according to claim 13.

16. A roof tent set comprising the clamping apparatus according to claim 1 and a roof tent having a bottom to which the clamping apparatus is attached or attachable.

17. A method for clamping a clamping apparatus to a roof rack profile, wherein the roof rack profile has a longitudinal axis, the method comprising the steps of:
i) placing a roof tent profile on the roof rack profile such that a groove of the roof tent profile the longitudinal axis of the roof rack profile;
ii) inserting a first clamping part into the groove in a first rotational position;
iii) rotating the first clamping part to a second rotational position; and
iv) moving the first clamping part and a second clamping part with respect to each other along the groove such that a first connecting portion and a second connecting portion can be connected to each other and the roof rack profile is positioned between the roof tent profile the first clamping part, and the second clamping part.
